(19) United States
(12) Patent Application Publication
(10) Pub. No.: US 2010/0140388 A1
(43) Pub. Date: Jun. 10, 2010

(54) AIR CUSHION LANDING SYSTEM AND METHOD OF OPERATION

(75) Inventors: Russell John London, Biggleswade (GB); Malcolm John COX, Southampton (GB)

Correspondence Address: MERCHANT & GOULD PC, P.O. BOX 2903, MINNEAPOLIS, MN, 55402-0903, US

(73) Assignee: Air Cushion Landing Systems Limited, Southampton (GB)

(21) Appl. No.: 12/564,729

(22) Filed: Sep. 22, 2009

Related U.S. Application Data
(63) Continuation-in-part of application No. PCT/GB2008/050196, filed on Mar. 19, 2008.

(30) Foreign Application Priority Data
Mar. 23, 2007 (GB) 0705642.7

(51) Int. Cl. B64C 25/32; F02K 1/00; B64B 1/20

(52) U.S. Cl. 244/5; 60/229; 244/100 A

(57) ABSTRACT

An aircraft air cushion landing system (2) includes a skirt (6) defining a plenum (22) on an underside of the aircraft, a plenum fan (26) arranged to induce an airflow into the plenum (22) and controller configured to control operation of the plenum fan (26). The controller includes a sensor (30) adapted to sense an imminent landing event and a fan control system (28) configured to automatically operate the plenum fan (26) to provide a first flow in a first direction out of the plenum (22) so that as the skirt (6) engages a landing surface air is being evacuated from the plenum (22). A method also operates such a system (2).

This application is a Continuation-in-Part of International Application No. PCT/GB2008/050196, filed 19 Mar. 2008, which claims benefit of Serial No. 0705642.7, filed 23 Mar. 2007 in Great Britain and which applications are incorporated herein by reference. To the extent appropriate, a claim of priority is made to each of the above disclosed applications.

### FIELD OF THE INVENTION

The present invention relates to an aircraft air cushion landing system and a method of operating one. More particularly, the invention relates to such a system and method for a hybrid aircraft employing a combination of buoyancy and aerodynamic lift for flying.

### BACKGROUND OF THE INVENTION

Conventional wheeled undercarriages are not suitable for use with hybrid aircraft and so-called air cushion landing systems have been proposed as an alternative. Such air cushion landing systems include one or more plenum chambers, each plenum chamber being surrounded by a skirt, having an open under surface and a means for supplying pressurised air to pressurise the plenum chamber. When the aircraft is on the ground, or other support surface such as a water surface, the skirt forms a seal, or partial seal, around a periphery of the plenum so that pressurised air in the plenum provides a force for supporting the aircraft. To facilitate taxiing, the skirt may be in the form of an annular inflatable tube with apertures in a ground-engaging surface through which a lubricating layer of air can leak. Alternatively, if taxiing is to take place over very uneven surfaces, flexible fingers may be provided projecting downwardly from an inflatable annular tube. Such fingers can be displaced as the aircraft passes over objects.

One problem that has been encountered with air cushion landing systems for hybrid aircraft is that when a high level of sink landing occurs and the skirt forms a good seal at its point of engagement, the severe shock that is imparted to the hybrid aircraft is a major design consideration and may result in components being strengthened and thereby made undesirably heavy. With this problem in mind, the plenum can be provided with venting valves which open once a predetermined threshold pressure difference between the inside of the plenum and ambient pressure occurs. This arrangement however suffers from a number of disadvantages. Firstly, venting the plenum in this manner may not act quickly enough so the shock loading on the aircraft is not sufficiently reduced. Secondly, the valves constitute additional components which add to the weight, complexity and cost of the hybrid aircraft. Thirdly, the cross-sectional area of ducting required to provide a significant venting capability is very large because air is only vented under the influence of the pressure differential existing between the plenum and the ambient atmosphere. Large ducts for such a purpose add still further weight, complexity and cost and can impinge on cargo storage space in the hybrid aircraft.

An object of the invention is to reduce landing shock in a hybrid aircraft using an air cushion landing system and to avoid at least some of the problems referred to above.

### SUMMARY OF THE INVENTION

Thus according to the invention there is provided an aircraft air cushion landing system including skirt means defining a plenum on an underside of the aircraft, a plenum fan arranged to induce an airflow into the plenum and control means configured to control operation of the plenum fan, wherein the control means include sensing means adapted to sense an imminent landing event and a fan control system configured to automatically operate the plenum fan to provide a first airflow in a first direction out of the plenum so that as the skirt means engages a landing surface, air is being evacuated from the plenum.

Such a system reduces the shock on the aircraft during a landing event by using the plenum fan and ducting, which is already part of the aircraft equipment thereby and avoiding the need to incorporate venting valves and associated ducting. Furthermore, the plenum fan in an aircushion landing system is, by necessity, a high capacity fan capable of delivering a high flow of air. Accordingly, its use to evacuate the plenum as touchdown occurs, and for a period thereafter, very effectively reduces the shock imparted to the aircraft. Also, the area of ducting through which venting occurs will be considerably smaller than that which would be required if valves were employed as a result of the assistance given to the evacuation by the fan prior to and during touchdown.

The control means may advantageously sense one or more of instantaneous skirt conditions including skirt pressure, skirt height and the proximity of the skirt to the ground and other conditions such as pressure inside the plenum.

The simplest way of sensing whether a landing event is imminent and the instantaneous skirt height immediately thereafter is to employ a sensor for measuring distance from the aircraft to the ground and the sensing means preferably includes such a sensor. Alternative methods envisaged include the use of a global positioning system in combination with ground level information or real-time data from an automated ground based landing system. Suitable sensors for measuring this distance include laser sensors and radar type sensors.

The sensing means may also include means for directly measuring vertical speed and/or acceleration. If the fan control system is provided with such information, the time available until touchdown and the velocity at touchdown can be used to compute when to commence evacuation of the plenum and the optimum evacuation flow rate and/or duration.

Preferably the fan control system includes means for subsequently controlling operation of the plenum fan so as to restrict flow of air in a first direction out of the plenum in order to cause plenum pressure to rise above ambient pressure to arrest, or partly arrest, downward movement of the aircraft. By using the plenum fan to restrict the flow of air out of the plenum, a variably throttling facility can be provided which can be adjusted to take account of sink rate at touchdown and the stage of the landing event which has been reached.

Advantageously the fan control system includes means for subsequently controlling the plenum fan so as to reverse the flow of air in order that it flows in an opposite second direction to thereby increase plenum pressure to raise the aircraft. Such a system permits significant collapsing of the plenum to occur, thus spreading the time and distance over which the arresting of downward movement of the aircraft can be effected. The plenum fan is also used to bring the aircraft up to the desired level for taxiing and mooring.

Preferably the plenum fan includes means for varying, including reversing, fan blade pitch actuated by means of the fan control system. This provides a very rapid and easily controllable way of varying the flow induced/allowed by the plenum fan.

Preferably the fan control also includes means for controlling rotation speed of the fan. This provides two parameters (speed and blade pitch) which can be balanced to provide the required flow and operate with minimum power consumption. After the fan has acted to restrict flow in the first direction (out of the plenum) caused by downward momentum of the aircraft compressing the plenum, the fan changes its function and it is operated to induce a flow in the second opposite direction to pressurise the plenum and thereby raise the aircraft.

The plenum fan preferably includes an energy-storing device for storing rotational kinetic energy and clutch means for selectively coupling the energy-storing device for rotation with the fan. With this arrangement, energy imparted to the fan by air forced out of the plenum can be stored in the energy-storing device then subsequently, and very rapidly, used to establish a reverse flow of air back into the plenum once fan blade pitch has been reversed.

Since the aircraft may not be landing on a level surface, skirt sealing with the landing surface may not be uniform and the aircraft may not be evenly loaded, an aircraft with an air cushion landing system may advantageously include plural air cushion landing systems as described above and a combined control means including aircraft attitude sensing means, the control means being configured to control operation of the plenum fans of the separate landing systems differentially in order to control aircraft attitude during a landing event. The attitude sensing means may advantageously include pitch and roll sensors.

According to a second aspect of the invention there is provided a method of operating an aircraft air cushion landing system including a skirt means defining a plenum on an underside of the aircraft, a plenum fan arranged to induce an airflow into the plenum and control means configured to control operation of the plenum fan, the method comprising the steps of:

(i) sensing an imminent landing event with sensing means; and
(ii) automatically controlling operation of the plenum fan with a fan control system to provide a first air flow in a first direction acting to evacuate the plenum as the skirt means engages a landing surface.

Preferably the method also includes the subsequent step of:

(iii) controlling operation of the plenum fan with the fan control system so as to restrict flow of air in the first direction out of the plenum in order to cause plenum pressure to rise above ambient pressure to arrest downward movement of the aircraft.

More preferably the method also includes the subsequent step of:

(iv) controlling operation of the plenum fan with the fan control system so as to reverse the flow of air in order that it flows in an opposite second direction into the plenum thereby increasing plenum pressure to raise the aircraft.

Conveniently, controlling of the operation of the fan is effected by means of controlling at least one of plenum fan rotation rate and plenum fan blade pitch. Very rapid reversal of the flow can be effected by reversing the fan blade pitch. It is also envisaged that aerodynamic performance of the fan may be adjusted by altering other aspects of its geometry.

### BRIEF DESCRIPTION OF THE DRAWINGS

The invention will now be described by way of example only with reference to the accompanying schematic drawings in which:

FIG. 1a shows an overall view of a system in accordance with the present invention;

FIG. 1b shows a portion of the skirt of the system shown in FIG. 1a;

FIG. 1c shows an individual skirt finger section of the skirt portion shown in FIG. 1b;

FIG. 2 shows the system of FIG. 1 in a state for taxiing;

FIG. 3 shows the system of FIG. 1 in a state for flying;

FIGS. 4a to g show the system of FIG. 1 during various states of a landing event;

FIG. 5 shows the system of FIG. 1 in a state for mooring the aircraft;

FIG. 6 shows details of the plenum fan depicted in FIG. 1a;

FIG. 7 shows details of a modified plenum fan with an energy-storing device;

FIG. 8 shows a flow diagram illustrating the various stages of the landing events; and

FIG. 9 shows part of an aircraft with two air cushion landing systems and a combined control system according to an alternative embodiment of the invention.

### DETAILED DESCRIPTION OF EMBODIMENT(S)

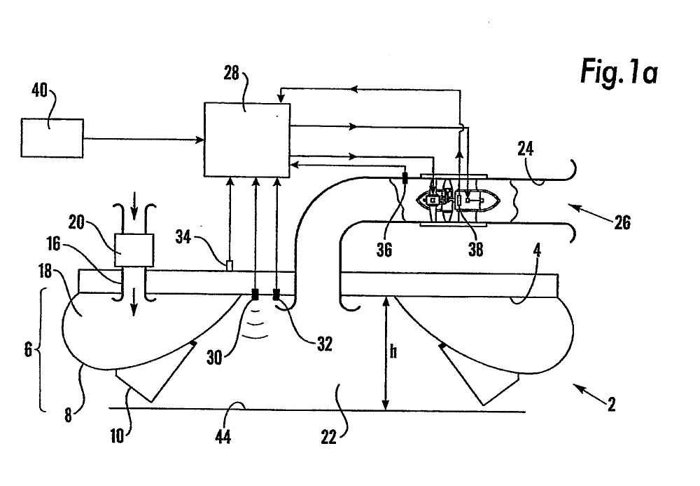

FIG. 1a shows an aircraft air cushion landing system 2 in accordance with the invention. An annular skirt 6 is connected to lower surface 4 of a fuselage of the aircraft. The skirt 6 comprises an annular inflatable skirt 8 to a bottom of which a finger skirt 10 is attached. As shown in FIG. 1b, the finger skirt 10 is composed of individual fingers 12, one of which is shown in isolation in FIG. 1c. Each finger 12 is attached to the inflatable skirt 8 with fixing means such as sewing 14. Lower portions of adjacent fingers 12 are not connected to each other so that the fingers may be displaced individually or in groups to allow the finger skirt 10 to easily pass over objects. A skirt duct 16 connects a skirt fan 20 to an interior 18 of the inflatable skirt 8. A plenum 22 is bounded and defined by the skirt 6 and a plenum fan 26 is connected to the plenum 22 by a plenum duct 24.

A control module 28 is provided for controlling the operation of the plenum fan 26 and receives input signals from a plenum height sensor 30, a plenum pressure sensor 32 and an ambient pressure sensor 34. The control module 28 may also receive signals from plenum duct pressure sensor 36, plenum fan sensor(s) 38 (which may provide signals relating to fan speed, fan torque and fan blade pitch, fan motor supply voltage and current drawn), and various supplementary inputs (which may include pilot control input, attitude, altitude and vertical acceleration and/or velocity). The control module 28 may therefore be used to control operation of the plenum fan in a fully automatic or semi-automatic mode. Alternatively, operation of the plenum fan 26 may be controlled manually by a pilot or remote operator of the aircraft. The signals from one or more of the various sensors and inputs mentioned above may be displayed to the pilot or remote operator to assist with the manual operation of the plenum fan 30. Alternatively, the pilot or remote operator may operate the plenum fan 28 solely by visually sensing an imminent landing event.

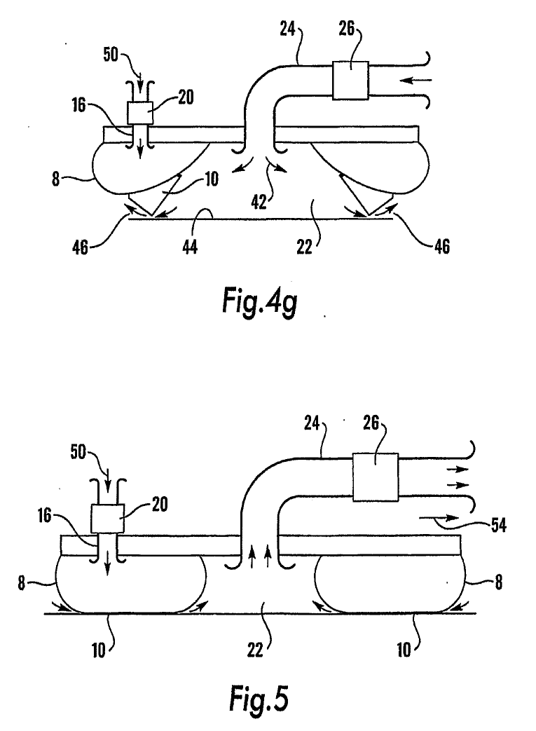

The construction of the plenum fan 26 is shown schematically in FIG. 6. The fan includes a casing 62 which is engaged at opposite ends by section of the plenum duct 24. The casing 62 has front and rear diametral support members 64 and 65 which support the main parts of the fan. A fan shaft 66 is mounted for rotation about a fan axis 68 and rotatable by an electric motor 70 mounted in the front support member 64. A fan impeller 72 is mounted for rotation with the shaft 66. The impeller 72 includes a hub 74 to an outer periphery of which impeller blades 76 are mounted by means of blade roots 78. Each blade root 78 is journaled for rotation about a blade axis 84 in the impeller hub 74 by means of a bearing 80 and has a pin 82 extended from the blade root 78 parallel to, but offset from, the associated blade axis 84. The pins 82 of all of the blades 76 are interconnected by a crosshead 86 which is displaceable by an actuator 88 in the direction indicated by double headed arrow X to adjust and reverse the pitch angle of the blades 76.

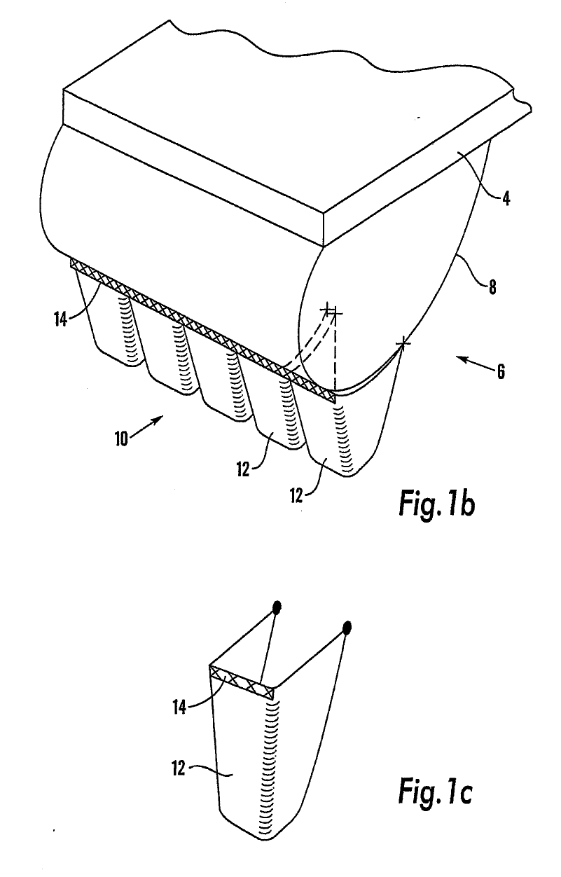

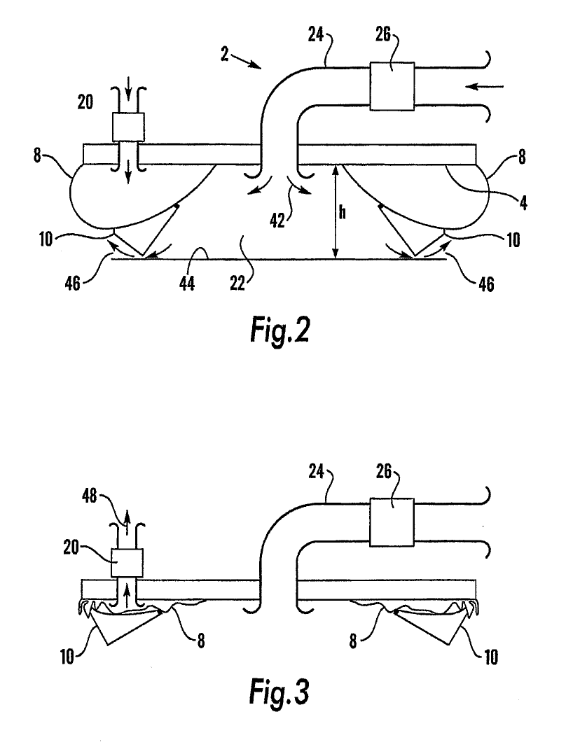

For the purpose of taxiing, the air cushion landing system 2 operates as shown in FIG. 2. The skirt fan 20 runs so as to pressurise the inflatable skirt 8. The plenum fan 26 is run so as to provide a plenum airflow 42 into the plenum so as to maintain the lower surface 4 of the aircraft at a height h above the ground 44 such that the finger skirt 10 just contacts and seals with the ground 44. A certain amount of plenum air 46 leaks out of the plenum 22 between the ground 44 and the finger skirt 10. Devices such as fans or jet engines (not shown) mounted elsewhere on the aircraft are operated to translate the aircraft when the air cushion landing system is in the state shown in FIG. 2.

For the purpose of flight the skirt fan 20 is run in the reverse direction so as to evacuate the inflatable skirt 8, as indicated by arrow 48 and the plenum fan 26 is switched off.

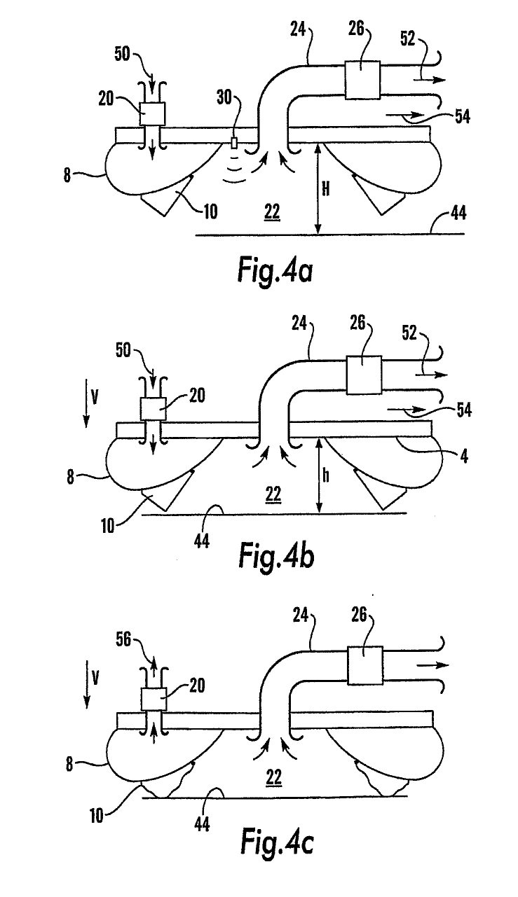

The sequence of steps employed during a landing event are described below with reference with FIGS. 4a to 4g in which the control system (shown in FIG. 1a) has been omitted for the purpose of clarity.

Throughout the steps shown in FIGS. 4a to 4g, the skirt fan 20 is running in the same direction to normally create a flow 50 of air into the inflatable skirt 8 or maintain pressure therein once it has become fully inflated. In certain steps (see FIGS. 4c and 4d) which will be explained more fully below, back-pressure from the inflatable skirt 8 causes the flow 50 to cease and in certain circumstances reverse i.e. flow 56 in the opposite direction to that being urged by the skirt fan 20.

As shown in FIG. 4a, the landing event commences when the aircraft descends to a point at which the height sensor 30 is a certain distance H above the ground 44. The skirt fan 20 inflates the inflatable skirt 8 and the control module 28 actuates the plenum fan 26 so that it creates a momentum airflow 52 out of the plenum 22 in a first direction 54 into the surrounding atmosphere.

As shown in FIG. 4b, the finger skirt 10 contacts and forms a seal with the ground 44 when the aircraft lower surface 4 is at a distance h from the ground 44 and touchdown occurs. The plenum fan 26 continues to drive a flow 52 of air out of the plenum 22.

FIG. 4c shows the stage, shortly after touchdown, when the fingers 12 of the finger skirt 10 have become partly compressed and the volume of the plenum has been reduced slightly. The control module 28 controls the operation of the plenum fan 26, by adjusting the pitch and/or rotation rate of the fan, to reduce the rate of extraction of air from the plenum 22 such that the pressure in the plenum increases and rises above the external atmospheric pressure to an appropriate extent. As a consequence of this differential pressure, a force is exerted by air pressure in the plenum 22 which acts to arrest the descent of the aircraft. Increased pressure in the plenum 22 acts on an inner surface of the inflatable skirt 8 causing the pressure therein to rise and a back-flow 56 of air from the inflatable skirt 8 through the skirt fan 20 occurs.

FIG. 4d shows the next stage in the landing event. Once the signal from the height sensor 30 signifies that the height of the plenum 22 has reduced to h′ the control module 28 adjusts the operation of the fan 26, by means of blade pitch and/or rotation rate adjustment, such that the fan restricts the flow 52 of air out of the plenum, so that the pressure in the plenum is maintained at a level above ambient pressure by an appropriate amount so that arresting of the descent of the aircraft continues. The airflow 52 out of the plenum 22 thus drives the fan.

FIG. 4e shows the stage at which the full “stroke” of the plenum has occurred (i.e. it has been reduced in height by the maximum permissible extent to a height h″). This is sensed by the control module 28 as a result of the signal from the height sensor 30. The descent of the aircraft has been arrested at this stage and the volume of the plenum is no longer reducing. The control module ceases restricting airflow out of the plenum 22 and the plenum fan is on the point of supplying air to the plenum 22 at a pressure sufficient for the plenum air pressure to support the weight of the aircraft. At this stage, the pitch of the blades of the plenum fan will be at zero so that rotation of the fan 26 neither drives air into nor out of the plenum 22.

FIG. 4f shows the next stage in which fan blade pitch has been reversed with respect to the pitch employed in the stages described above. Consequently, a second flow of air 58 in a second direction 60 into the plenum is established to raise the aircraft until the height of the plenum reaches the full plenum height h (the dimension shown in FIG. 2 for taxiing) and the plenum pressure is sufficient to support the weight of the aircraft. As this raising of the aircraft occurs, the skirt fan 20 causes a flow 50 of air into the inflatable skirt 8.

Thereafter, the flow of air into the plenum 22 can be maintained by the plenum fan 26 so that a leakage 46 of plenum air under the finger skirt occurs if taxiing is to take place, as shown in FIGS. 2 and 4g.

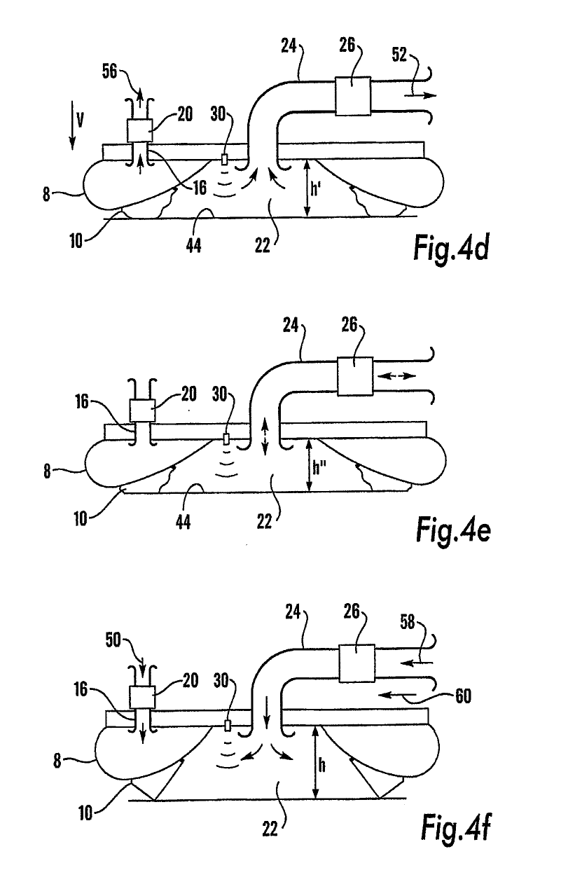

Alternatively, if parking is to occur, the skirt fan 20 is left running and the flow induced by the plenum fan 26 is reversed (i.e. flow in the first direction 54 out of the plenum is established) so that the finger skirt 10 is collapsed and the inflatable skirt 8 is squashed as shown in FIG. 5. The skirt 6 then acts to restrain the aircraft against lateral movement and moors it. The extraction of air from the plenum is maintained at an appropriate rate to restrain the aircraft against unwanted movement.

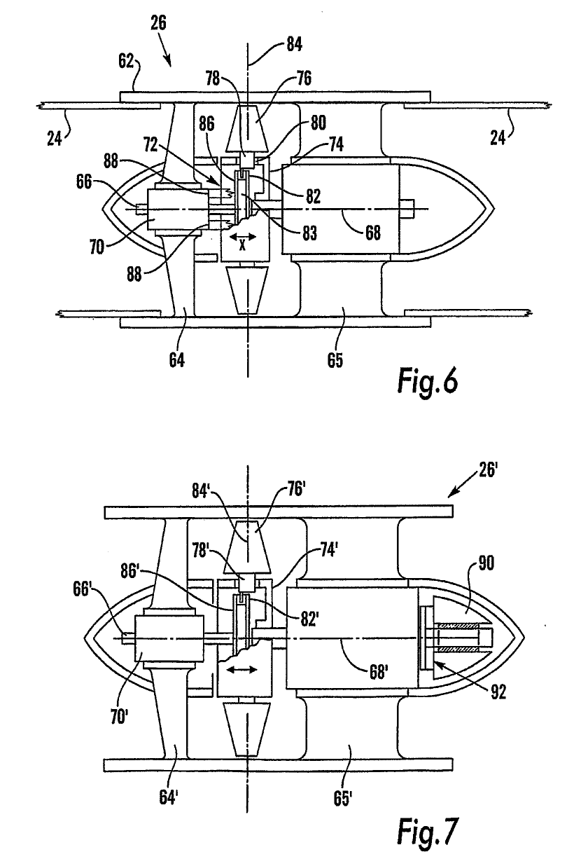

As mentioned above, during some portions of the landing event (stage described with reference to FIGS. 4c and 4d), air being forced out of the plenum through the plenum fan drives the fan impeller 72. To prevent excessive fan impeller rotation speed building up, the plenum fan 26 may include a kinetic energy storing device as shown in the modified fan 26′ depicted in FIG. 7, in which like parts have been designated by the same numbers with a prime notation. The fan 26′ differs from the fan 26 shown in FIG. 6 in that it includes a flywheel 90 which is selectively couplable for rotation with the shaft, 66′ by means of a clutch 92. The energy stored by the flywheel 90 during the middle phases of the landing event (the stages shown in FIGS. 4c and 4d) becomes available at the end of the landing event (the stage shown in FIG. 4f) to contribute to bringing the plenum up to its full pressure and height h. The clutch 92 is operated under the control of the control module 28.

During landing of the aircraft the control module computes the pad plenum pressure required to arrest the descent of the aircraft within the available “stroke” of the pad, and during the landing event, compares it with the instantaneous pad plenum pressure as indicated by the sensors. The control module causes the adjustment of the geometry of the fan impeller and/or the fan motor speed to obtain the required instantaneous plenum pressure.

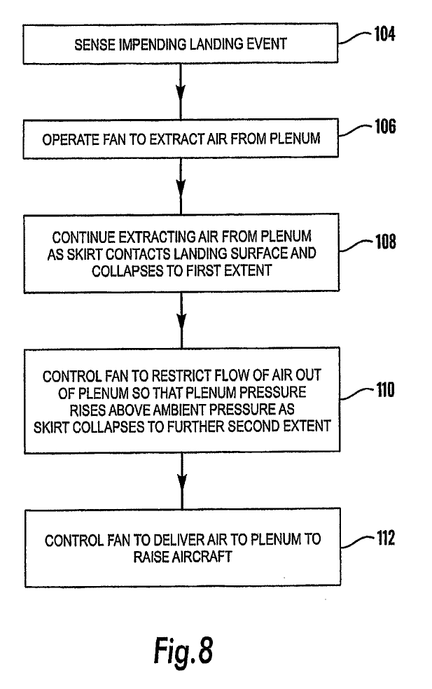

FIG. 8 shows a self explanatory flow diagram including the major steps 104 to 112 involved in the method according to the invention.

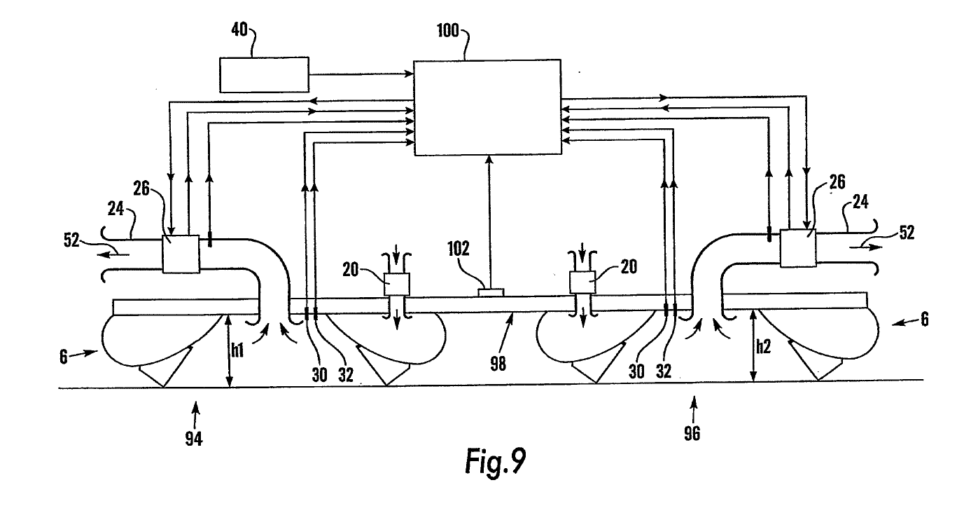

FIG. 9 shows an air cushion landing system in accordance with a second embodiment of the invention in which first and second air cushion systems 94 and 96 are provided. Parts of each air cushion system which correspond to the air cushion described above are designated by the same numerals. The main difference from the single air cushion landing system described above is that a combined control module 100 is provided. This control module 100 will operate both of the air cushion systems substantially as described above. In addition however the control module 100 will compare the height h1 of the plenum of the first system 94 with the height h2 of the plenum of the second system 96. If a difference between h1 and h2 is detected, the operation of the fans of the first and second systems is adjusted to bring h1 and h2 into or towards. convergence. In the event of the aircraft having to land on an inclined surface, the combined control module 100 may be arranged to control differential fan adjustment on the basis of output from an inclination sensor 102, rather than plenum height sensors, so as to maintain the aircraft in a horizontal attitude.

While FIG. 9 shows an air cushion landing system employing two air cushions a typical hybrid aircraft may include four or possibly more air cushions which could be jointly controlled by a combined control module configured to compensate for pitch and roll as the aircraft is landed.

While specific examples of air cushion landing systems and methods of operating them have been provided, it would be appreciated that variations to the systems and methods could be made by a skilled person in the art which still fall within the scope of the appended claims.

1. Aircraft air cushion landing system including skirt means defining a plenum on an underside of the aircraft, a plenum fan arranged to induce an airflow into the plenum and control means configured to control operation of the plenum fan, wherein the control means includes sensing means adapted to sense an imminent landing event and a fan control system configured to operate the plenum fan to provide a first flow in a first direction out of the plenum so that prior to and during engagement of the skirt means with a landing surface during the landing event, air is being evacuated from the plenum.

2. The landing system of claim 1 wherein the sensing means includes distance measuring means for measuring distance from the landing surface.

3. The landing system of claim 2 wherein the sensing means includes means for measuring at least one of vertical speed and vertical acceleration of the aircraft.

4. The system of claim 1 wherein the fan control system includes means for subsequently controlling operation of the plenum fan so as to restrict flow of air in the first direction out of the plenum in order to cause plenum pressure to rise above ambient pressure to arrest downward movement of the aircraft.

5. The system of claim 1 wherein the fan control system includes means for subsequently controlling the plenum fan so as to reverse the flow of air in order that it flows in an opposite second direction into the plenum to thereby increase plenum pressure to raise the aircraft.

6. The system of claim 1 wherein the plenum fan includes means for varying fan blade pitch actuated by means of the fan control system.

7. The system of claim 1 wherein the fan control system includes means for controlling rotation speed of the fan.

8. The system of claim 1 wherein the plenum fan includes an energy storing device for storing rotational kinetic energy and clutch means for selectively coupling the energy storing device for rotation with the fan.

9. An aircraft including plural air cushion landing systems according to claim 1 and a combined control means including aircraft attitude sensing means, the control means being configured to control operation of the plenum fans of the separate landing systems differentially in order to control aircraft attitude during a landing event.

10. A system according to claim 1, wherein the aircraft is a hybrid aircraft.

11. A method of operating an aircraft air cushion landing system including a skirt means defining a plenum on an underside of the aircraft, a plenum fan arranged to induce an airflow to deliver air into the plenum and control means configured to control operation of the plenum fan, the method comprising the steps of:
(i) sensing an imminent landing event;
(ii) controlling operation of the plenum fan with a fan control system of the control means to provide a first airflow in a first direction out of the plenum and acting to evacuate the plenum prior to and during engagement of the skirt means with a landing surface during the landing event.

12. The method of claim 11 wherein sensing the imminent landing event includes sensing a distance from the landing surface.

13. The method of claim 11 including the subsequent step of:
(iii) controlling operation of the plenum fan with the fan control system so as to restrict flow of air in the first direction out of the plenum in order to cause plenum pressure to rise above ambient pressure to arrest downward movement of the aircraft.

14. The method of claim 13 including the subsequent step of:
(iv) controlling operation of the plenum fan with the fan control system so as to reverse the flow of air in order that it flows in an opposite second direction into the plenum thereby increasing plenum pressure to raise the aircraft.

15. The method of claim 13 wherein controlling operation of the fan is effected by means of controlling at least one of plenum fan rotation rate and plenum fan blade pitch.

16. The method of claims 15 wherein reversing the flow of air is effected by reversing fan blade pitch.

17. The method according to claim 14 wherein the plenum fan includes an energy storing device for storing rotational kinetic energy and a clutch means for selectively coupling the energy storing device for rotation with the fan and wherein both during the restriction of flow of air out of the plenum in step iii and during the reversal of the airflow in step iv the clutch means is engaged.

18. A method of operating plural landing systems of an aircraft, each system including skirt means defining a plenum on an underside of the aircraft, a plenum fan arranged to induce an airflow into the plenum and control means configured to control operation of the plenum fan, wherein the control means includes sensing means adapted to sense an imminent landing event and a fan control system configured to operate the plenum fan to provide a first flow in a first direction out of the plenum so that prior to and during engagement of the skirt means with a landing surface during the landing event, air is being evacuated from the plenum and the plural landing systems having a combined control means, the method being in accordance with claim 11 and including the additional steps of sensing aircraft attitude and the combined control means controlling operation of the plenum fans of the separate landing systems differentially in order to control aircraft attitude during a landing event.

19. A method according to claim 11 wherein the aircraft is a hybrid aircraft.
